(19) United States
(12) Patent Application Publication
(10) Pub. No.: US 2002/0002635 A1
(43) Pub. Date: Jan. 3, 2002

(54) Presentation of an active window in a terminal and method of using same

(76) Inventors: Arto Astala, Vantaa (FI); Charlotta Willstedt, Linkoping (SE); Marcus Davidsson, Linkoping (SE); Tapio Mansikkaniemi, Espoo (FI); Otso Ylonen, Salo (FI); Anders Frisk, Menlo Park (SE)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/738,328

(22) Filed: Dec. 18, 2000

Related U.S. Application Data
(63) Continuation-in-part of application No. 09/607,409, filed on Jun. 30, 2000.

(51) Int. Cl. G06F 9/00; G06F 9/54; G06F 15/163; G06F 9/46

(52) U.S. Cl. 709/328; 709/310

(57) ABSTRACT

A method and device are provided for accessing the internet. A first internet web page may be accessed using a terminal. The first internet web page may be displayed on a display of the terminal. Features of the first internet web page may be displayed within a first active window of the terminal. A user may subsequently select the first active window and have a browser reaccess the first internet web page. The first internet web page may then be displayed again on the display.

This patent application is a Continuation-in-Part of U.S. application Ser. No. 09/607,409, filed Jun. 30, 2000, entitled “Presentation Of An Active Window In A Terminal And Method Of Doing the Same”.

### RELATED APPLICATIONS

This application is related to the subject of related U.S. application Ser. No. 09/609,581 entitled “Network with Mobile Terminals Having Wireless Access to the Internet and Method for Doing Same” and the browser arrangement in the terminal, which is the subject of related U.S. application Ser. No. 09/607,637 entitled “Network with Mobile Terminals as Browsers Having Wireless Access to the Internet and Method for Using Same” the subject matters of which are incorporated herein by reference. This application is also related to the subject of related U.S. application Ser. No. 09/607,359 entitled “System and Method for Providing a Virtual Keyboard for a Wireless Terminal”, a two-fingered navigational tool, which is the subject of related U.S. application Ser. No. 09/608,174 entitled “Handheld Terminal with Removable Data Storage Module Incorporating a Display Multiple Scrolling Means”, a two-fingered pressure sensitive special click-drag-drop feature, which is the subject of related U.S. application Ser. No. 09/607,638 entitled “Method and Apparatus for Touch Screen Input”, and a unique Graphical User-Interfaces (GUI), which is the subject of related U.S. application Ser. No. 09/607,369, the subject matters of which are incorporated herein by reference.

### FIELD OF THE INVENTION

This invention relates generally to communication networks and more specifically relates to mobile terminals in a network with information management services and internet accessibility.

### BACKGROUND OF RELATED ART

Known methods of providing access to the internet include connecting to the internet through an internet service provider (ISP). Typically, a user may select one ISP and use that ISP to gain access to the internet. In order to gain access to the internet through the ISP, the user must have a terminal capable of connecting to the ISP. Additionally, the terminal must also have the ability to retrieve information from the internet. For example, a typical personal computer (PC) may have a communication port with a communication device, such as a modem, that can connect to the selected ISP via a landline. Once connected, the PC may have an internet navigational tool, such as a web browser, stored in the PC's memory. The user may use the navigational tool to navigate through the internet to retrieve and display the desired information on a monitor. However, the limitation of such a system is being able to provide cost effective portability and mobility. For example, a portable PC or laptop computer can be carried from one location to another; however, accessing the internet or other related services typically requires costly connection fees and charges, such as fees charged by the hotel.

Wireless units provide a user with a more portable and mobile unit. These wireless units may be thin devices with most of its functionality stored in a remote location. A thin device is a device having most of the functionality stored and carried out remotely. For example, a thin device may not have its own web browsing capability. Given that the user's wireless unit is a thin unit, it may depend entirely on the system for interaction with other services, such as the internet, and packaging of the information in a format that is compatible with the user's wireless unit. The wireless unit interfaces with systems having the ability to package and transmit information to the wireless units. Typically, the system has internet accessibility and navigational capability so that the system may retrieve, package and transmit information to the wireless unit. In order to receive the information, a remotely located system packages the information for the wireless unit. For example, a system connected to the internet can retrieve information from the internet, package that information so that the information is compatible with and can be wirelessly transmitted to the user's wireless unit.

Since the user's wireless unit is portable there is a chance that the user's wireless unit will enter a network that is not in communication with the system that provides the user's wireless unit with the desired data. Consequently, if the user's wireless unit is operating in the network and there is no system capable of packaging and transmitting the requested information to the wireless unit, then the user's wireless unit is of little use.

Another problem is that the user may not be capable of sharing information with other users, storing and retrieving information specific to the user, and having multiple users that access the same information using the same wireless unit while allowing individual access for each user through the shared wireless unit. For example, the user may not be able to view or retrieve calendar information for other users that may be grouped with the user. Furthermore, the user may not be able to lend the wireless unit to a second user and have the second user access information individual to the second user.

Mobile system applications may be presented to the user as user friendly as possible so that the user can focus on the content of the system application or the internet browsing.

One problem with mobile terminals is that user may see on the display the selected application, the mobile system application or a browser in such a way that user has to give control commands and see the content of the selected service or browser.

Additionally, networks with mobile terminals are desired to provide easy access to mobile system application pages without the user being shown technical details of the mobile terminal system, but rather to show the information that user needs to be aware of. Additionally, a user having a handheld mobile terminal with a certain sized display may have a problem to see all required and available services and or applications that can be used next. Two or more applications may be required to be used essentially concurrently in such a way that the user easily switches from one application to another. The user may also have to recognize the content of a non-active window in such detail that the user may make a decision of selecting the window to be an active window.

### SUMMARY OF INVENTION

A method is provided for using a terminal having a display. The method may include accessing at first the main login view of the mobile terminal, displaying the first page on a display of the terminal and displaying features (i.e., a snapshot) of the system applications on the main page within a first active window of the terminal including system services and/or the internet browser as one application available for the terminal user. The displayed features of the login main menu (when a common PC or mobile system terminal is used as the terminal) may be presented on the user interface on the display in such a way that the user interface does not look like a normal browser session when the mobile system services are presented and selected although the system services are accessed from the terminal to the network system by applying the browser application of the terminal.

The method may include using the selected active window and switching to another currently active non-selected window in such a way that the previously another non-selected active window is changed to be the selected active window and the previously selected active window is changed to be the non-selected active window.

The method may also include that the selected and the non-selected active window may include a view of a system service or a browser.

The method may also include that the switching from the currently selected active window to the non-selected active window is initiated by the user by pressing a hardware button of the terminal.

The method may also include that the selected active window fills the full content area of the user interface of the terminal display.

The method may also include that the selected active window fills essentially half of the content area of the user interface of the terminal display.

The method may also include that the non-selected active window fills essentially half of the content area of the user interface of the terminal display.

The method may also include that the image of the non-selected active window is static. The user may then easily recognize the service or application within the non-selected active window.

The method may also include that the image of the non-selected active window is dynamic and that the image content is updated according to the service or application within the non-selected active window.

The method may also include that the image of the non-selected active window is dynamic and is updated either periodically or essentially in real time.

The method may include that the user of the terminal may relocate a position of the first active window within the display.

Preferably the system services, which the user or user group such as the family has been authorized to use and which are presented in the active window(s), are available from a server located via the internet from the network.

Preferably the configuration or user interface of the service application of the system may be managed remotely by one operator or service provider of the mobile system to access the network or internet.

### BRIEF DESCRIPTION OF THE DRAWINGS

The invention will be described with reference to the following drawings in which like reference numerals represent like elements and wherein:

FIG. 1 is a block diagram of a communication network having mobile terminals;

FIG. 2 is a block diagram of the server of FIG. 1;

FIG. 3 is a block diagram of a mobile terminal that operates within the system of FIG. 1;

FIG. 4 is a flowchart of operations for establishing a shared session and an individual session between the mobile terminal and the server;

FIG. 5 is a flowchart of operations for establishing a communication link between the mobile terminal and the server;

FIG. 6 is a diagram of a display screen having active windows according to an example embodiment of the present invention; and

FIG. 7 is a diagram of an active window according to an example embodiment of the present invention.

### DETAILED DESCRIPTION OF PREFERRED EMBODIMENTS

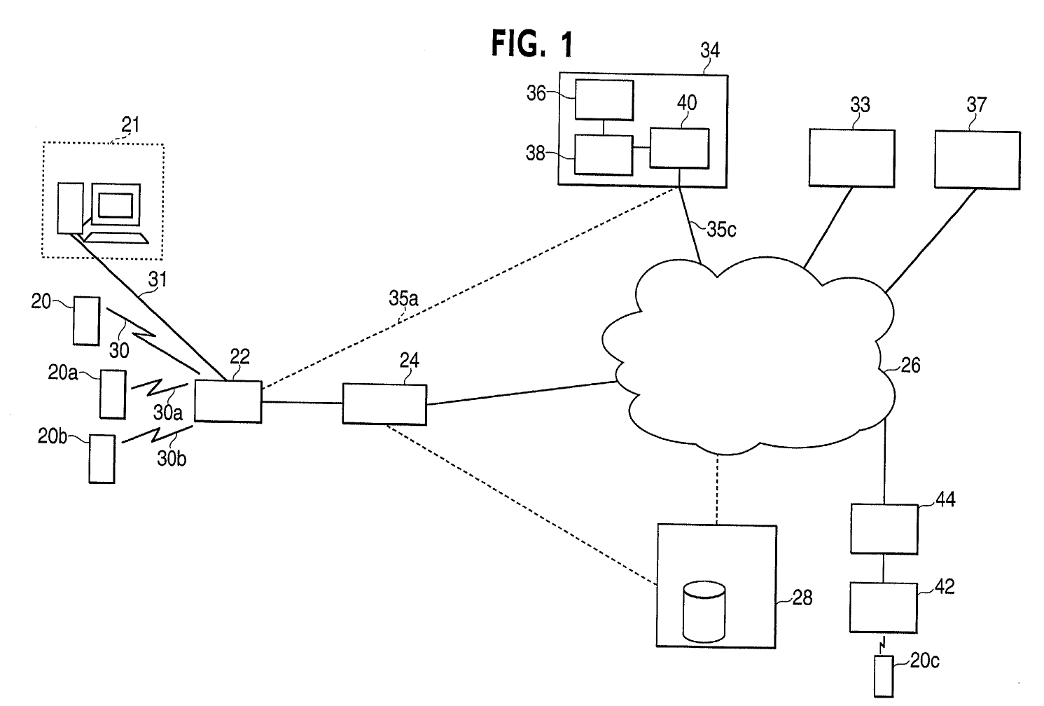

FIG. 1 illustrates a network 10 having a terminal 20 coupled to an access point 22. The access point 22 may be coupled to an internet service provider (ISP) 24, which is coupled to the internet 26. Accordingly, the access point 22 may have an internet address relative to the internet address of the ISP 24. Additionally, the ISP 24 may be coupled to a server 28 that provides the user with specific services and features through the terminal 20. The server 28 may be coupled directly to the internet 26 and then the terminal 20 would access the server 28 through the internet 26.

The terminal 20 may include a virtual keyboard, which is the subject of related U.S. application Ser. No. 09/607,359 entitled “System and Method for Providing a Virtual Keyboard for a Wireless Terminal”, a two-fingered navigational tool, which is the subject of related application Ser. No. 09/608,174 entitled “Handheld Terminal with Removable Data Storage Module Incorporating a Display Multiple Scrolling Means”, a two-fingered pressure sensitive special click-drag-drop feature, which is the subject of related U.S. application Ser. No. 09/607,638 entitled “Method and Apparatus for Touch Screen Input”, and a unique Graphical User-Interfaces (GUI), which is the subject of related U.S. application Ser. No. 09/607,369, the subject matters of which are incorporated herein by reference. The server 28 may provide services such as email, calendar, notes, ability to shop on line and necessary authentication as well as third party services and information, which is the subject of related U.S. application Ser. No. 09/609,581 entitled “Network with Mobile Terminals Having Wireless Access to the Internet and Method for Doing Same” and the browser arrangement in the terminal, which is the subject of related U.S. application Ser. No. 09/607,637 entitled “Network with Mobile Terminals as Browsers Having Wireless Access to the Internet and Method for Using Same”, the subject matters of which are incorporated herein by reference.

The terminals 20, 20a, and 20b may be coupled to the access point 22 via the wireless connections 30, 30a, and 30b, respectively, such that the user may have portable or mobile access to the internet 26 and the services provided by the server 28. Additionally, a personal computer (PC) terminal 21 may be coupled to the access point 22 via a landline 31. The terminal 21 can access the server 28 using special authentication by any user authorized to access the information and services provided by the server 28. However, the authentication for the user using the terminal 21 may be slightly different from the authentication procedure for the terminals 20, 20a, 20b, and 20c. More specifically, the terminal 20 may be coupled to the access point 22 using a wireless local-area-network gateway (WLAN GW) that is installed at a specific location such as the user's location. The WLAN GW interface may use Ethernet 802.11 transfer protocol, for example. However, other wireless interface protocols, such as GPRS of Global System for Mobile Communications (GSM+), Universal Mobile Telecommunication Systems (UMTS), or other LAN, may also be used. If the terminal 20 is powered on and within range of the access point 22, then Ethernet protocol may be used as a transfer protocol in order to establish and maintain a communication link.

Although the terminal 20 is shown as being coupled to the server 28 through the ISP 24, other embodiments and configurations are also available. For example, the terminal 20 may be coupled directly to the server 28 through the access point 22. Regardless of how the terminal 20 is coupled to the server 28, once the terminal 20 is authenticated the terminal 20 may function as an internet browser to access the internet 26 and retrieve services and information from the server 28. Furthermore, the ISP 24 may be separate from and not acting as the server 28 and vice versa, even though they may be combined into one unit.

Even though the access point 22 is shown as being coupled to the ISP 24 through a landline 32, other embodiments and configurations are also available. For example, the access point 22 may be wirelessly coupled to the ISP 24. The terminal 20 may access the ISP 24 through the access point 22 and the user may access, navigate through, and retrieve information from the internet 26 using the terminal 20.

In order for a terminal, such as the terminal 20, to have access to the services of the server 28, the server 28 may authenticate and authorize the terminal's access. Although only the authentication and authorization procedure relating to the terminal 20 are discussed herein, the teachings are also applicable to other terminals. Upon proper authentication of the terminal 20, the user may access the services of the server 28 at the authorized level of authentication.

Generally stated, if the terminal 20 is powered on and authenticated by the server 28, then information or services from the server 28 may be downloaded to the terminal 20. The server 28 may download information such as profile settings for the group. One profile setting that can be downloaded is language preferences for a shared communication session. Other information or services may include configuration data, driver or application related software or portions thereof, configurable parameters, partial sections of system software, or configurable parameters depending on the level of authentication that has occurred with respect to the user. Additionally, the terminal can have access through proper authentication and service providers to third party publications available from a content provider or vendor 33 such as news related information found in magazine publications or daily newspapers. The information may be purchased by the user and then transmitted by the vendor 33 upon request of the user's group at the server 28 and then to all terminals within the group of the terminal 20. Alternatively, the information may be purchased by an operator/owner of the services provided by the terminal 28 and then resold to each group as requested. Thus, a group profile can also include access to the information services of the vendor 33 that can be made available to the group or just the user depending on the authentication.

The configuration of the system services or the user interface may be saved in the server 28 and this may be managed remotely by configuration tool manager 38 of management server 37 that upgrades any software component, full executable software program or reconfigures configuration parameters; application and system parameters.

Two levels of authentication may provide access to the services and information of the server 28, namely a group level and an individual level. The group level may be a level of authentication that occurs based on the identity of the terminal 20 in order to initiate a shared session. In order to create a group at least one terminal is needed. However, several terminals may make up a group such as the terminals 20a, 20b, and 20c. Each terminal may have a unique identity that allows that terminal access to a shared session at the group level. Furthermore, each group may include a specific group profile that may be downloaded during a shared session from the server 28. Thus, anyone having access to the terminal 20 may have access to the group level information and services such as calendar, e-mail, bookmarks, cookies, and e-publications, all of which are setup for the group. These same services may be available to the user at the individual level although the content of the information may vary. The server 28 may include storage capacity for storing data related to the group in a group specific storage unit that can be accessed and used by all terminals within the group once the terminal has been authenticated and the shared session initiated.

The group level authentication may be based on the identity of the hardware of the terminal 20. The authentication may occur automatically to initiate the shared session once the terminal 20 is powered on. Alternatively, authentication at the group level may not occur automatically. For example, the terminal 20 may request input from the user in order to initiate the group level authentication process. Once the terminal 20 accesses the services, then each user of the terminal 20 may access information and services that are available to all users in the group as well as initiate an individual communication session to access individual information and services available only to that user provided the user has a profile associated with the group associated with the terminal that established the shared session in progress.

Unlike the shared session at the group level, an individual session at the individual level may be a level of authentication that requires input from the user to allow the user of a terminal (such as the terminal 20 or the terminal 20c) access to information intended only for that user. For example, the user may use any terminal that is within the user's group and initiate an individual session to access information and services specific to that user. The authentication can be done using anything that is unique and only known by that user such as a password. Thus, the user can initiate an individual session regardless of which terminal is being used. When the user activates an individual session then configuration parameters, which are specific to the user, may be downloaded to the terminal 20. The user may have a profile associated with the same group that is similar to the terminal's profile. Furthermore, the network 10 may be set up to allow a user access from any terminal regardless of the association between the user, the terminal 20, and the group as long as the user can be authenticated by the server 28. This is similar to the way a user may gain access to the server 28 from the terminal 21.

As indicated above, anyone having access to the terminal 20 may have access to the group level information and services because authentication is based on the terminal 20 and may occur automatically and the shared session is always active when the terminal 20 is powered on. Even though any user of the terminal 20 may have access to information and services at the group level, only a designated user can change the group or take actions on behalf of the group. One or two users within the group may be designated to have administrative rights for the group. The user/users with administrative rights may be called a group administrator. The group administrator may have the right to alter group profiles. Information related to the group administrator may be stored in the server 28 and administration access can be authenticated by a password. The group administrator, once authenticated, may alter the group profile settings, add or delete terminal profiles from the group profile, and add or delete user profiles from the group profile.

One group setting that the group administrator can select is the language setting for the shared sessions. However, each user can select his or her own language preference for the individual sessions. For example, in a multilingual group, the group language can be one specific language while the language for each user may be different during the individual session for that user. Then depending on the session type, which is either family or individual, the terminal 20 may show text in the selected language that is established in the group or individual profile, respectively.

Additionally, the group administrator may have access to purchasing services that may require the ordering party to be of legal age for the purpose of ordering or purchasing additional services such as news or publication services. Thus, while all users of the terminal may have access to group level services such as access to the internet, they may not be able to make administrative decisions unless they were authenticated as the group administrator. Accordingly, the group may be protected from unauthorized or unwanted alteration of group profile as well as financial commitments occurring at the group level from the terminal 20, especially given that the identity of the user of the terminal 20 is not unknown at the group level and that user has access to the server 28 as well as the internet 26 through the terminal 20 coupled to the ISP 24.

In addition to the ISP 24, the access point 22 may also be coupled to a global unit or content provider 34. In one embodiment, the access point 22 may communicate with the content provider 34 through a link 35a. Alternatively, the access point 22 may communicate with the content provider 34 through the landline 32, the ISP 24, and a link 35b. In yet another alternative, the access point 22 may communicate with the content provider 34 through the landline 32, the ISP 24, the Internet 26, and a link 35c.

The content provider 34 may include a global address server 36, a global upgrade server 38 and a firewall unit 40. The firewall unit 40 may function to provide secured access to the global address server 36 and the global upgrade server 38.

The internet address of the business unit 34 with the global address server 36 may be contained in the memory of the terminal 20. Even though reference is made hereinafter to the internet address of the global address server 36 without specific reference to the internet address of the content provider 34, the internet addresses for the two may be the same or could be slightly different depending on configuration parameters. The global address server 36 may be a place from which all the terminals (such as the terminals 20, 20a, 20b, and 20c) may fetch the internet address of their respective server. The advantage of having the terminal 20 store the internet address of the global address server 36 is that if the terminal 20 was relocated near another access point, then the terminal 20 can still obtain the internet address location of the server 28 by knowing the internet address of the global address server 36. The internet address of the server 28 may also be stored on the terminal 20 and the memory of the terminal 20 may be updated as needed.

An advantage to storing the internet address of the global address server 36 on the terminal 20 is that the association between terminal and server as well as changes in the internet address of servers can be easily and efficiently updated without having to update the memory of each terminal. The global update server 38 may update the global address server 36 each time there is a change in the association between terminal and server, when there are new terminals to associate with a server, or if the internet address of a particular server is changed.

With the internet address of the global address server 36 stored in the memory of the terminal 20, the terminal 20 may be able to request and retrieve the internet address of the server 28 from the global address sever 36. The global address server 36 may store information about the location of the server 28 and all other servers in the network and the corresponding relation between each terminal and its server. Thus, the terminal 20 may be always able to obtain the address of the server 28, which is the server designed to serve the terminal 20. For example, the terminal 20c coupled through an access point 42 to an ISP 44 can retrieve the internet address of the server 28 from the global address server 36 provided that the server 28 is the server designated to serve the terminal 20c and that the terminal 20c is authenticated by the server 28 as an authorized user of the services.

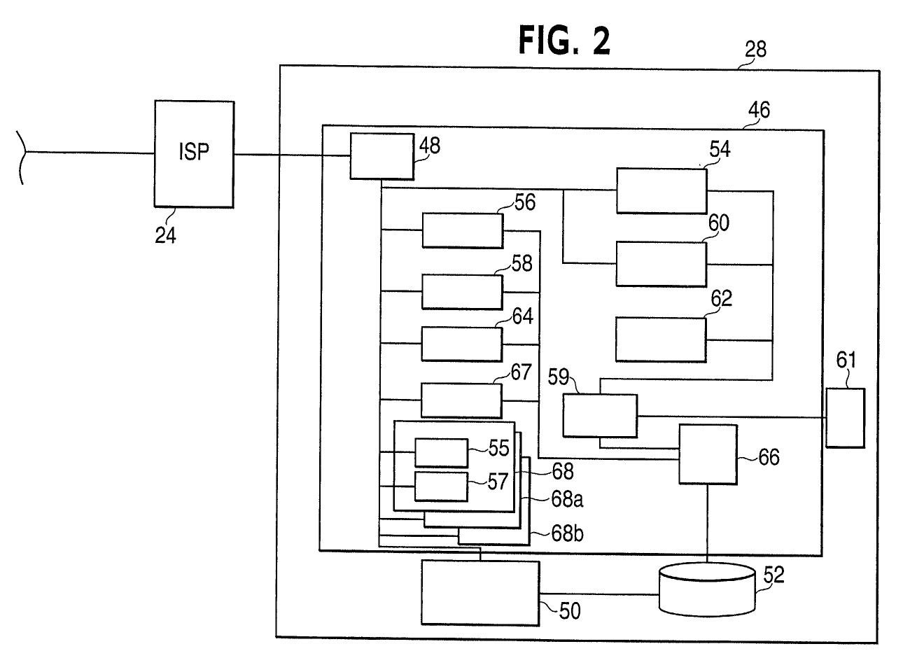

FIG. 2 shows that the server 28 may include a support server 46, a response handler or application server 48, a network application server 50 and a directory server 52. The referenced connections represent logical elements between the devices. The support server 46 may provide services oriented towards enabling and supporting the services provided to the terminal 20. The support server 46 may include an upgrade service unit 54, a bookmark service database unit 55, a login services unit 56, a bookmark database 57, a profile services unit 58, a client log unit 59 for collecting information about clients, and to be included into web browsing client object specific units 68, 68a, 68b, a system log unit 61 for collecting information about events in the server 28 from the client log unit 59, an advertisement services unit 60, an administrative services unit 62, a defined services unit 64 and a directory client unit 66.

The upgrade services unit 54 may be a specific means for controlled software upgrade of the software for the support server 46. Updates may be transmitted from the global upgrade server 38 to the upgrade service unit 54. The login services unit 56 may provide the means for authentication of the user and the terminal 20 that is being used to access the services based on information provided by the client unit 66. Additionally, the login services unit 56 may be responsible for log-off activities such as individual session termination. The profile services unit 58 may provide the means for modifying a user's profile information (e.g. group and individual information and preferences). The administration services unit 62 may provide the means for administration of the support server 46 and the application server 48. The advertisement services unit 60 may provide the means for the server 28 to tailor advertisements to the user and the terminal 20 according to the user's profile information. The defined services unit 64 may be a classification of ‘other services’ containing items like bookmark management services, help services, log services, name management services and general management services. The directory client unit 66 may be coupled to the directory server 52 to provide client verification. The remote register management and control unit 67 may know the closest or the global terminal validation register address and control unit 67 may also interpret the answer received from the register.

The support server 46 may also include web browsing client object specific units 68, 68a, 68b—as many as required to support all the individual and concurrent web browsing sessions and the user terminal group profile as well as individual terminal user profiles. The profiles that are to be served may, for example, belong to the people living in the same premises and possessing separate and several terminals.

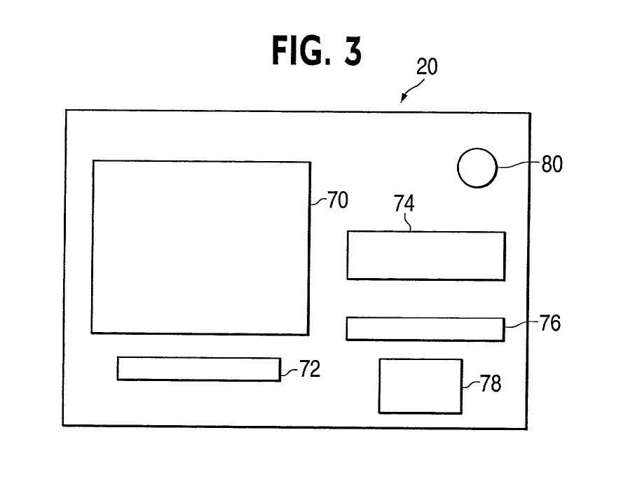

FIG. 3 is a block diagram of a mobile terminal that operates within the system of FIG. 1. The terminal 20 may include a display 70, a user interface (UI) framework 72, a browser 74, a driver 76 and hardware 78. The driver 76 may reside in the memory of the hardware 78 along with other data such as the internet address of the global address server 36 and software such as the browser 74. As the terminal 20 is turned on, the driver 76 may retrieve data relating to the internet address of the global address server 36. The driver 76 may be EPOC6, which is operating system software that handles hardware related functions in the terminal as well as offers a functioning environment to the application layer programs. Once the terminal 20 is powered on, the terminal 20 may be coupled to the access point 22 and the ISP 24. Thus, the terminal 20 may be able to obtain its own internet address.

Using the internet address of the global address server 36, the terminal 20 may be coupled to the global address server 36 and send a request in order to obtain the internet address of the server 28. Once the terminal 20 has the internet address of its server 20, it may then be coupled to the server 28. The server 28 may authenticate that the terminal 20 has group level access privileges by using the unique identity of the hardware 78 of the terminal 20. Accordingly, the terminal 20 may be authenticated and logged onto the server 28 to begin a shared session at a group level. Thus, the user may access services or retrieve information from the server 28 or the internet 26. In order for the user to initiate an individual session and retrieve individual information, the user may use the terminal 20 and provide further authentication to the server 28 to gain access at the individual level. At either the group level or the individual level, the user may retrieve information related to the group of users as well as browse the internet 26 to retrieve information.

The browser 74 may be a typical browser and include such features as Hyper-Text Transfer Protocol (HTTP), JAVA script and cascade style sheet capability. As with typical personal computers (PCs), the browser 74 may help the user navigate through and retrieve information from the internet once the user is connected to the ISP 24 through the terminal 20. The user may utilize the terminal 20 to connect to both the ISP 24 and the server 28 using authentication protocol. The terminal 20 may be the primary means of access by the user to the server 28 and the related services and applications. However, the user may also access the ISP 24 and the server 28 using the terminal 21 or non-mobile terminal using appropriate group level authentication initiated manually.

In order to retrieve information or request services from the server 28 or the internet 26, the user may provide input through the UI framework 72. The user can provide input using a virtual keyboard displayed on the display 70. Even though the virtual keyboard may be used to retrieve information from the internet 26, the user may also receive the information at the display 70 of the terminal 20 in a full screen format. A full screen format may be available because the UI framework 72 may disappear when the user types a universal resource locator (URL) or follows a hyperlink while navigating the internet 26. In order to return to the UI framework 72, the user may press a button 80 and the virtual keyboard as well as the header and footer related to the services may be presented again. Additionally, once the user presses the button 80, the web page (i.e., a full screen displayed prior to pressing the button 80) may be reduced to a thumbnail view and positioned in the display 70 such as in the bottom left corner. Consequently, the user has a shortcut to quickly access the web page that was previously visited or to save that web page as a bookmark.

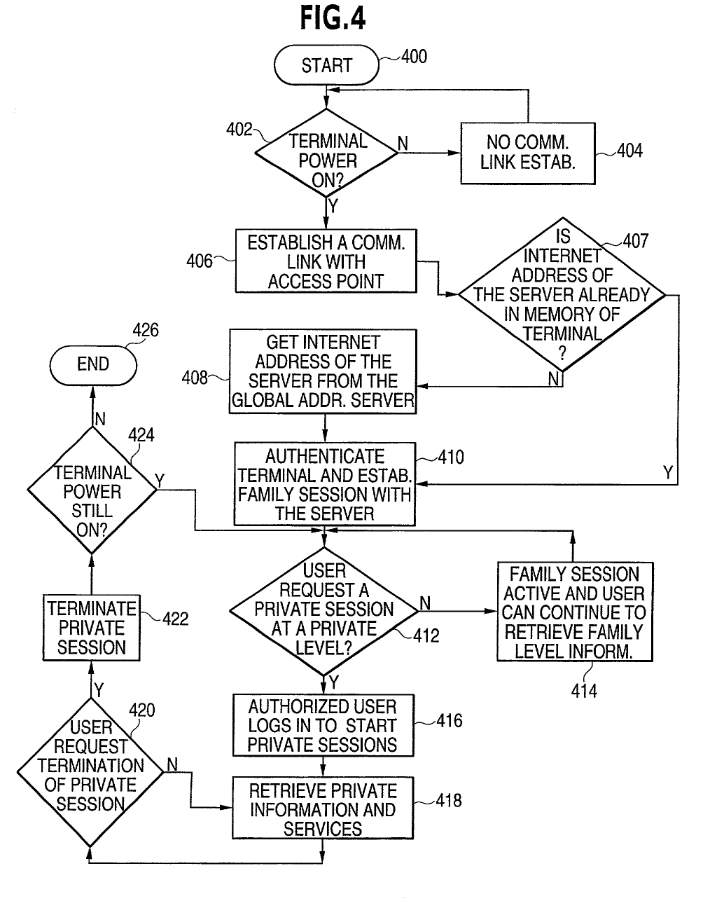

FIG. 4 is a flowchart beginning at block 400 showing operations of authenticating a terminal at the group level to initiate a shared session and authenticating the user at the individual level to initiate an individual session. Other embodiments and operations for performing the features are also available. At block 402, it is determined whether the terminal is powered on. If it is determined that the terminal is not powered on in block 402, then a communication link cannot be established through an access point to the server in block 404 and operations return to block 402 until the terminal is powered on. On the other hand, if the terminal is powered on in block 402, then the terminal may establish a communications link connection to the access point (block 406) to an ISP and a global address server. At block 407, it is determined if the internet address of the server is known by the terminal. If the internet address of the server is not known at block 407, then the terminal obtains the internet address of its server from the global address server at block 408. Alternatively, if it is determined that the terminal knows the address of its server at block 407, then operations may proceed to block 410.

At block 410, the terminal communicates with the server and is authenticated as an authorized terminal with access to information and services at the group level. The shared session begins and continues until the terminal is turned off. Additionally, the group profile may be downloaded to the terminal when the shared session is active. Once the server recognizes the terminal, then establishing the shared session may be an automatic background activity carried out by the terminal and transparent to the user. In order for the user to establish an individual session and access individual information and services, the user may log in as an individual user at the individual level.

At block 412, it is determined if the user is an authorized individual user. If the user is not authenticated as an individual user in block 412, then the user may only be given access to a shared session with the group level information and services in block 414. On the other hand, if the user is an authorized individual user at block 412, then an individual session may be established at block 416 and the user may be allowed access to the individual information and services. Although the individual level information and services may be the same for all users, the content may vary from user to user.

In the individual session, the user may retrieve information and use the individual level services provided by the server in block 418. At block 420, it is determined if the user wants to terminate the individual session and return to the group level. If it is determined that the user does not want to terminate the individual session in block 420, then the user may continue the individual session at the individual level and operations may return to block 418. On the other hand, if it is determined that the user wants to terminate the individual session in block 420, then the individual session is terminated and the user goes from the individual level to the group level at block 422. At block 424, it is determined if the terminal is still powered on. If the terminal is powered on in block 424, then operations may return to block 412 with the user at the group level in a shared session. Otherwise, if the terminal is turned off in block 424, then the shared session is also terminated and the terminal may be logged off of the server at block 426.

Once the server authenticates the terminal, then a shared session may begin at the group level. Once the user is recognized as an individual user, then an individual session may be initiated. Consequently, an individual session may remain in effect until the user explicitly terminates the individual session whereas a shared session may remain in effect until the terminal is turned off Additionally, during a shared session when a predetermined period of time expires without any input from the user, then the terminal 20 can enter a standby mode in order to conserve battery life until the terminal 20 receives an input from the user. Other features can be included such as termination of the individual session if no input is received from the user after a predetermined period of time.

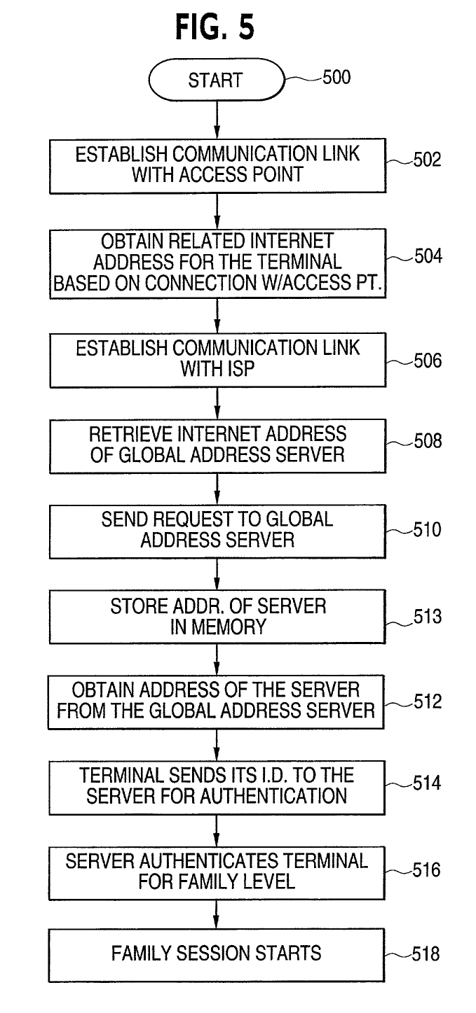

FIG. 5 is a flowchart showing operations for establishing a communication link to an access point (block 406 of FIG. 4) and obtaining the internet address of a server for that terminal (block 408 of FIG. 4) for initiating a shared session at the group level. Operations may begin at block 500. Other embodiments and operations for performing these features are also available. At block 502, the terminal may establish a communication link with the access point. At block 504, the terminal may obtain its internet address from the access point based on the internet address of the access point with which the terminal has established the communication link. At block 506, the terminal may establish a communication link with the ISP coupled to the access point. At block 508, the terminal may retrieve the internet address of the global address server from its memory. At block 510, the terminal may send a request to the global address server for the internet address of the server that is associated with the terminal. At block 512, the global address server may return the internet address of the appropriate server to the terminal. At block 513, the internet address of the server may be stored in the terminal's flash memory. At block 514, the terminal may send its identification information to the server located at the internet address provided by the global address server in order to establish a communication link with the server. At block 516, the server may authenticate the terminal and a shared session at the group level is established between the server and the terminal.

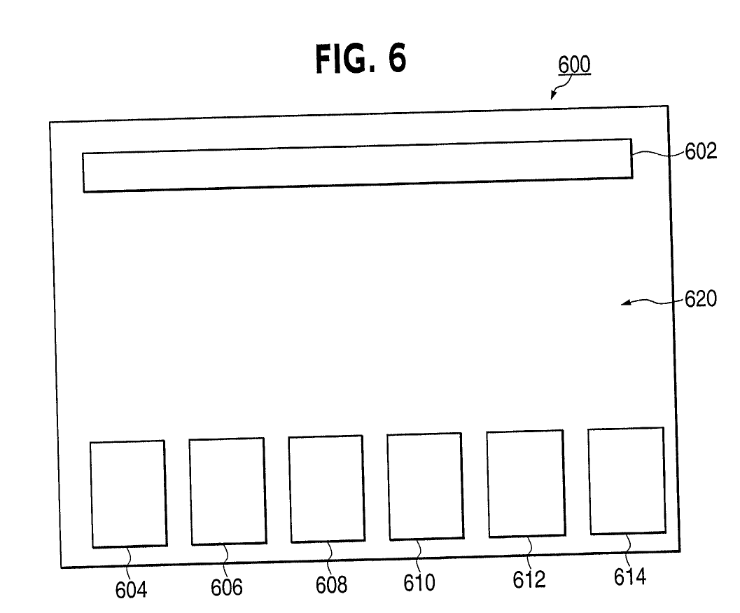

FIG. 6 is a diagram of a display screen according to an example embodiment of the present invention. Other embodiments and configurations are also within the scope of the present invention. More specifically, FIG. 6 shows a display 600 similar to the display 70 shown in FIG. 3. The display 600 may include a user interface (UI) area 602 and a main display area 620. The UI area 602 may visually represent the internet address (i.e., URL link) of a web page currently being accessed or displayed. The main display area 620 may display the currently selected window within the system service or web browsed page is presented. The image within the main display area 620 may change based on the user's interactions. The user may subsequently obtain other information on the internet or the selected system service such as a calendar or e-mail of a group of users (such as a family) or an individual user. As previously indicated, the terminal 20 may include the display 70 (or display 600), the user interface framework 72, the browser 74, the driver 76 and the hardware 78. In operation, these components may operate together such that the software controlling the browser 74 accesses the internet and displays various web pages and other information such as mobile system services such as calendar or e-mail information retrieved from the system server (element 28 in FIG. 1 and 2) on the display 600. Accordingly, the software of the browser 74 operates in conjunction with the UI framework 72 to appropriately obtain and display items on the display 600 when the user is not actively browsing (e.g., by using the world wide web) but also when system services from the server (element 28 in FIG. 1 and 2) are selected and used. When the system services such as a calendar service is used from the server, the user may not recognize from the view of the terminal display that the connection between the terminal and the server applies the browser software program. The usage of the browser may be hidden from the terminal user when system services such as calendar or e-mail service is in use. Applying the browser program in the connection between the mobile terminal and the server (element 28 in FIG. 1 and 2) is only one alternative and other transfer protocols and applications may be applied between the referred equipment entities compared to WLAN and browser. When the global internet browsing is the service that the user has intentionally selected, then the user can see in the user interface such features that are commonly known in browsers (e.g., bookmarks). When the user of the terminal browses the global internet then, for example, the display 600 may display the home page of a specific internet site.

In operation, the browser 74 may access the internet based on the URL link provided in the UI area 602. Other means of accessing the system services or the global internet are also available. Embodiments of the present invention allow a user to access an internet web page or an activated service application and subsequently display a snapshot of the accessed page or service application view or part of the view on the display 600 in an active window. For example, FIG. 6 shows an active window 604 in the lower left hand corner of the display 600. The location of the active window 604 may be anywhere on the display 600 (or anywhere on the terminal) and may be repositioned by the user. The active window is a visual representation (i.e., a thumbnail image) of a web page or a screen view of the system service application. For example, the active window may represent a previously visited web page or system service information regarding the active window may be stored in a memory of the terminal as a “Favorite” web page of the user.

The user may obtain the snapshot within the active window 604 by hitting (physically or virtually) an appropriate selection key and/or moving a cursor over the appropriate selection key. This may allow the browser 74, the user interface framework 72, and the other associated components (such as a controller) of the terminal to obtain and possibly store a visual representation of the web page on the active window 604. The controller may be configured to obtain the thumbnail image based on the previously displayed web page or information stored in the memory of the terminal. This active window 604 is visually shown as a shrunken snapshot or thumbnail image at a certain section (i.e., such as a lower level) of the display 600. The snapshot of the window may be snapshot of the full window or of part of the window. The user may use the display 600 and/or the browser 74 for other uses while the active window 604 displays the visual representation of the web page. For example, a user may access another web page and have that web page displayed in the main display area 620 in a typical manner. The unselected shrunken image or partial image of the window may be static as created when the selected window is changed to another window. The image of the unselected shrunken window may also be dynamic in such a way that it is updated in essentially real-time or periodically. When the shrunken window image or partial image of the window is dynamically updated it gives additional information to the user in such a way that the user is able to make a decision of when the information of the unselected active window is such that change from unselected into selected active window is required or wanted to be done.

FIG. 6 shows six active windows, namely active windows 604, 606, 608, 610, 612 and 614, each of which are capable of separately displaying a separate web page as a thumbnail image. While FIG. 6 shows these six active windows, the present invention is also applicable to a different number of displayed active windows that may be displayed at other locations.

The unselected active windows 604, 606, 608, 610,612 or 614 and the selected active window area 620 may also have essentially same size area of the display area 600.

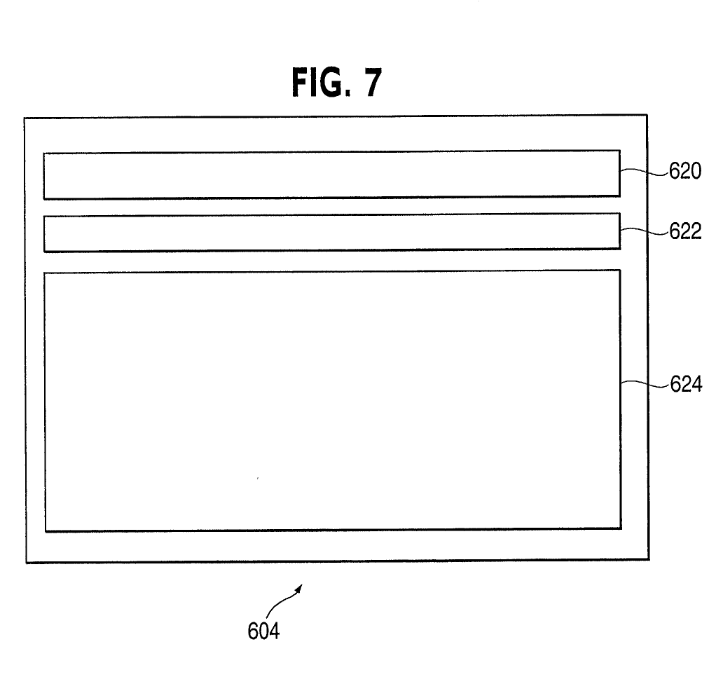

FIG. 7 is a diagram of an active window according to an example embodiment of the present invention. Other embodiments and configurations of an active window are also within the scope of the present invention. More specifically, the active window 604 may include a first section 620 that displays the URL address of the selected web page and a second section 622 that displays a title of the selected web page when browsing the global internet is the present activity. Then, the active window 604 may include a third section 624 that includes a snapshot of the actual web page, such as a thumbnail picture of a home page of the web site.

As discussed above, the display 600 shown in FIG. 6 shows six active window 604-614 each of which may be configured (i.e., specifically located) by the user of the terminal. While FIG. 6 shows six active windows, the present invention is not limited to this number of active windows.

Embodiments of the present invention allow the user to appropriately select one of the active windows such as active window 604. Upon being selected, the browser 74 may access the web page corresponding to the selected active window and display the selected internet page on the main display area 620. The web page previously displayed may not be displayed on the main display area 620. Stated differently, by selecting one of the active windows, that specific web page may be accessed and enhanced from the shrunken snapshot previously shown in the active window 604. The active window may be selected in any one of a number of ways including, for example, touching fingers or a wand on a touchscreen, using physical selection keys, or moving a cursor over the active window or other type of selection mechanism.

Embodiments of the present invention provide an easier method for users to access desired web pages based on a visual representation of the web page. The user may find forgotten links and home pages using the visual representation. Further, if the first section 620 containing the URL link and/or the second section 622 containing the title may be used by the user to find a desired web page. Stated differently, the URL link and/or title may be used in conjunction with the visual representation in the third section 624 to find a previously viewed web page. The active windows 604-614 may provide an easier visual method for a user to determine which web page he desires to access. Those active windows may correspond to a user favorite web page or may correspond to the immediately previously viewed web pages.

Embodiments of the present invention may be applicable to any PC, personal digital assistant (PDA) and/or any mobile display appliance (MDA) terminal to access desired web pages, store desired information and display appropriate pages including the active windows. The active window may be especially advantageous for a user that travels to a different country having a different language. When accessing the internet in a different culture, the user may not be able to recognize or obtain certain web pages due to the language barrier. However, the user may be able to access selected internet pages based on visual representations of the respective pages in the active windows. That is, a visual representation may be more recognizable.

The active windows 604-614 may contain a static representation of the respective web page that may be recognizable at any time. Alternatively, the active window may contain a dynamic snapshot of the web page. In such a case, the user may recognize a change in the contents of the active window 604 and realize that it is time to access that window. A dynamically changing active window may require additional resources (i.e., memory and bandwidth) than that necessary for a static active window environment.

Active windows provide the selection of windows within an application such as the browser 74. The visual representations of the internet pages allow a user to appropriately find and access desired internet pages more easily. These windows may be immediately seen and recognized without scrolling, stacking or other effects. This may also be achieved by presenting as active windows only those windows that relate to a certain task such as browsing generic internet pages. Selecting windows that relate to using MDA services may be selected by other means and windows that relate to management of the device itself may selected by yet another mechanism.

While the invention has been described with reference to specific embodiments, the description of the specific embodiments is illustrative only and is not to be considered as limiting the scope of the present invention. That is, various other modifications and changes may occur to those skilled in the art without departing from the spirit and scope of the invention.

What is claimed is:

1. A method of using a terminal having a display, said method comprising:
accessing a first application using said terminal,
displaying said first application on said display; and
displaying features of said first application within a first active window of said terminal.

2. The method of claim 1, wherein said displayed features of said first application comprise a visual representation of said first application.

3. The method of claim 2, wherein said displayed features further comprise a URL link of said first application when the first application is a browser for internet browsing.

4. The method of claim 1, wherein said displayed features of said first application is one of a plurality of system services applications.

5. The method of claim 4, wherein said system service application is one of a calendar, an e-mail and a notice board.

6. The method of claim 1, further comprising:
accessing a second application using the terminal; and
displaying said second application on said display while said features of said first application are displayed within said first active window of said terminal.

7. The method of claim 6, further comprising displaying features of said second application within a second active window of said terminal while displaying said features of the first application within said first active window.

8. The method of claim 6, wherein the second application is a browser for internet browsing.

9. The method of claim 6, wherein the second application is one of a plurality of system service applications comprising a calendar, an e-mail and a notice board.

10. The method of claim 1, further comprising:
selecting said first active window;
reaccessing the first application after selecting said first active window; and
displaying said first application on said display after selecting said first active window.

11. The method of claim 1, further comprising relocating a position of said first active window within said display.

12. A method of using a terminal having a display, said method comprising:
displaying features of a first application within a first window on said display; and
displaying features of a second application within a second window on said display.

13. The method of claim 12, wherein said displayed features of said first application comprise a visual representation of said first application.

14. The method of claim 13, wherein said displayed features further comprise a URL link of said first application when the first application is a browser for internet browsing.

15. The method of claim 13, wherein said displayed features further comprise a partial view of the first application.

16. The method of claim 12, further comprising:
selecting said first window;
accessing said first application after selecting said first window; and
displaying said first application on said display after selecting said first window.

17. The method of claim 16, further comprising:
selecting said second window subsequent to displaying said first application;
accessing said second application after selecting said second window; and
displaying said second application on said display after selecting said second window.

18. The method of claim 16, wherein the first application is one of an internet browser, a calendar, an e-mail and a notice board.

19. The method of claim 16, wherein the second application is one of an internet browser, a calendar, an e-mail and a notice board.

20. A terminal for accessing an application comprising:
a browser that accesses at least a server;
a display device coupled to the browser to display a view of said first application; and
a user interface device coupled to the display device that allows a user to interact with items displayed on said display device, the display device to display features of said first application within a first active window of said display device.

21. The terminal of claim 20, wherein said displayed features of said first application comprise a visual representation of said view of said first application.

22. The terminal of claim 21, wherein said displayed features further comprise a URL link of said first application when the first application is a browser for internet browsing.

23. The terminal of claim 20, wherein said displayed features are one of calendar, e-mail and notice board for said first application.

24. The terminal of claim 20, wherein said browser accesses a second application and said display device displays a view of said second application while said features of said first application are displayed within said first active window.

25. The terminal of claim 24, wherein said display device displays features of said second application within a second active window while displaying said features of the first application within said first active window.

26. The terminal of claim 20, wherein said user interface device is used to select said first active window, said browser reaccessing the first application based on said selection, and said display device displays said view of said first application after said selection of said first active window.

27. The terminal of claim 20, wherein said user interface device allows a user to relocate a position of said first active window within said display device.

28. A terminal for accessing application services, said terminal comprising a display device and a controller coupled to said display device so as to control items displayed on said display device, said controller to display features of a first application within a first window on said display device and said second controller to display features of a second application within a second window on said display device.

29. The terminal of claim 28, wherein said displayed features of said first application comprise a visual representation of said first application.

30. The terminal of claim 29, wherein said displayed features further comprise a URL link of said first application when the first application is a browser for internet browsing.

31. The terminal of claim 28, wherein said displayed features comprise one of calendar, e-mail and notice board for said first application.

32. The terminal of claim 28, further comprising a user interface device to allow a user to select said first window, wherein said controller uses a browser to access said first application after selecting said first window and said display device displays said first application after selection of said first window.

33. The terminal of claim 32, wherein said user interface device allows a user to select said second window subsequent to said display device displaying said first application, wherein said controller uses a browser to access said second application after selecting said second window and said display device displays said second application after the selection of said second window.
